(19) United States
(12) Patent Application Publication
(10) Pub. No.: US 2005/0144509 A1
(43) Pub. Date: Jun. 30, 2005

(54) Cache search accelerator method

(76) Inventor: Fernando Zayas, Loveland, CO (US)

Correspondence Address: FLIESLER MEYER, LLP, FOUR EMBARCADERO CENTER, SUITE 400, SAN FRANCISCO, CA, 94111, US

(21) Appl. No.: 10/890,804

(22) Filed: Jul. 14, 2004

Related U.S. Application Data
(60) Provisional application No. 60/532,474, filed on Dec. 24, 2003.
(60) Provisional application No. 60/532,457, filed on Dec. 24, 2003.

(51) Int. Cl. G06F 12/16

(52) U.S. Cl. 714/5; 711/112; 711/118

(57) ABSTRACT

A search engine of a hard disk drive is used to search both cache lists and defect lists.

### CLAIM OF PRIORITY

This application claims priority to U.S. Provisional Application No. 60/532,474 entitled “Cache Search Accelerator Method”, filed Dec. 24, 2003 and U.S. Provisional Application No. 60/532,457 entitled “Cache Search Accelerator”, filed Dec. 24, 2003.

### FIELD OF THE INVENTION

The present invention relates to hard disk drives.

### BACKGROUND

Rotating media storage devices, such as hard disk drives, are an integral part of computers and other devices with needs for large amounts of reliable memory. Rotating media storage devices are inexpensive, relatively easy to manufacture, forgiving where manufacturing flaws are present, and capable of storing large amounts of information in relatively small spaces.

A typical rotating media storage device having a rotatable storage medium includes a head disk assembly and electronics to control operation of the head disk assembly. The head disk assembly can include one or more disks. In a magnetic disk drive, a disk includes a recording surface to receive and store user information. The recording surface can be constructed of a substrate of metal, ceramic, glass or plastic with a very thin magnetizable layer on either side of the substrate. Data is transferred to and from the recording surface via a head mounted on an arm of the actuator assembly. Heads can include one or more read and/or write elements, or read/write elements, for reading and/or writing data. Drives can include one or more heads for reading and/or writing. In magnetic disk drives, heads can include a thin film inductive write element and a magneto-resistive read element. An actuator, such as a Voice Coil Motor (VCM), is used to position the head assembly over the correct track on a disk by rotating the arm.

### SUMMARY

Embodiments of the present invention concern the use of a search engine on a hard disk drive to search both a cache list and a defect list. The cache list and the defect list can be maintained in a memory. Entries of the cache list point to recently accessed data. Entries of the defect list indicate blocks of a hard disk with defects. The cache list can be searched to determined whether recently read or written data is stored in a relatively fast cache memory. The defect list can indicate the defects on the hard disk drive and thus allows for a translation between a logical block address and a physical block address.

### BRIEF DESCRIPTIONS OF THE DRAWINGS

FIG. 1 is a diagram of a rotating media storage device of one embodiment of the present invention.

FIG. 2 is a functional diagram illustrating a one embodiment of the present invention.

FIG. 3 is a flow chart of one embodiment of the present invention.

### DETAILED DESCRIPTION

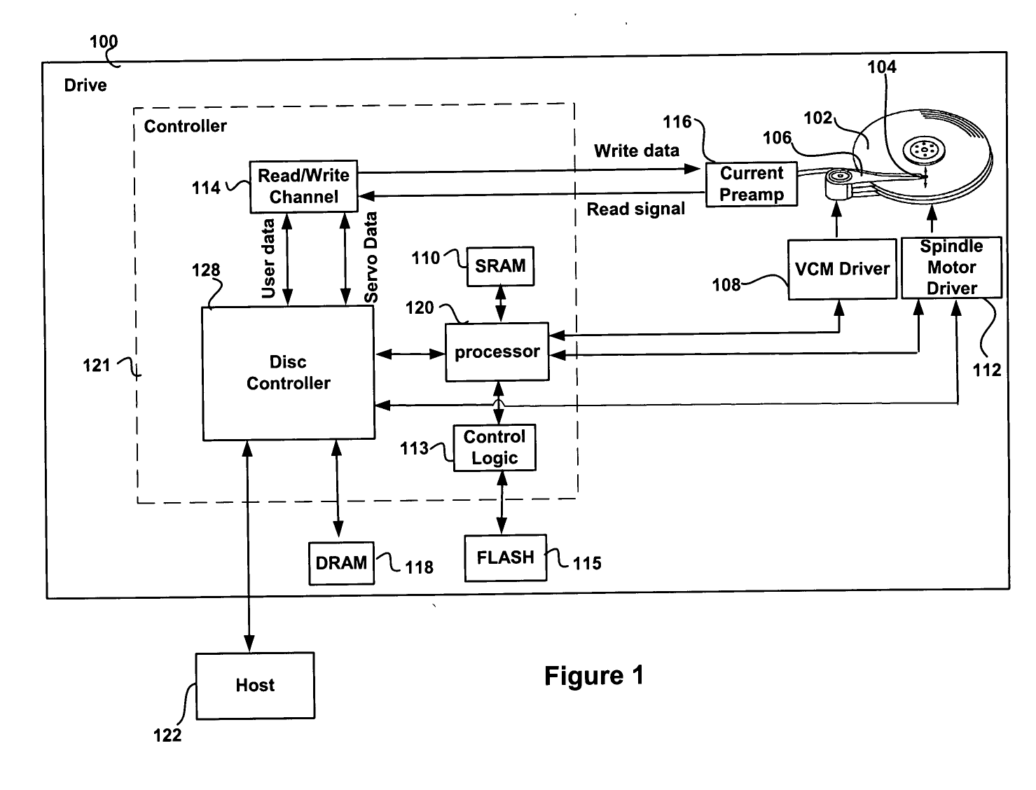

FIG. 1 shows a rotating media storage device 100 that can be used in accordance with one embodiment of the present invention. In this example, the rotating media storage device 100 is a hard disk drive. The rotating media storage device 100 includes at least one rotatable storage medium 102 capable of storing information on at least one surface. Numbers of disks and surfaces may vary by disk drive. In a magnetic disk drive, storage medium 102 is a magnetic disk. A closed loop servo system, including an actuator arm 106, can be used to position head 104 over selected tracks of disk 102 for reading or writing, or to move head 104 to a selected track during a seek operation. In one embodiment, head 104 is a magnetic transducer adapted to read data from and write data to the disk 102. In another embodiment, head 104 includes separate read elements and write elements. The read element can be a magnetoresistive (MR) head. Multiple head configurations may be used.

The servo system can include an actuator unit 108, which may include a voice coil motor driver to drive a voice coil motor (VCM) for rotating the actuator arm 106. The servo system can also include a spindle motor driver 112 to drive a spindle motor (not shown) for rotating of the disk 102. Controller 121 can be used to control the rotating media storage device 100. The controller 121 can include a number of arrangements. In one embodiment, the controller includes a disk controller 128, read/write channel 114, processor 120, SRAM 110, and control logic 113 on one or multiple chips. The controller can include fewer elements as well.

In one embodiment, the controller 121 is used to control the VCM driver 108 and spindle motor driver 112, to accept information from a host 122 and to control many disk functions. A host can be any device, apparatus, or system capable of utilizing the data storage device, such as a personal computer or Web server. The controller 121 can include an interface controller in some embodiments for communicating with a host and in other embodiments; a separate interface controller can be used. The controller 121 can also include a servo controller, which can exist as circuitry within the drive or as an algorithm resident in the controller 121, or as a combination thereof. In other embodiments, an independent servo controller can be used.

Disk controller 128 can provide user data to a read/write channel 114, which can send signals to a current amplifier or pre-amp 116 to be written to the disk(s) 102, and can send servo signals to the microprocessor 120. Controller 121 can also include a memory controller to interface with memory such as the DRAM 118 and FLASH memory 115. FLASH memory 115 can be used as non-volatile memory to store code and data. DRAM 118 can be used as a buffer memory and to store the code to be executed along with the SRAM 110.

In one example, the controller 121 includes a processor 120 that interacts with control logic 113 to access the flash 115. In one embodiment, the flash 115 is a serial flash and control logic 113 is used for accessing the data for the serial flash 115. Host 122 can also interacts with the processor 120. The controller 121 can also be used for the servo control reading and writing of data to the disk and to other memories such as the SRAM 110 and the DRAM 118. In one embodiment, the controller 121 can include multiple processors. The processor 120 can implement some or all off the control functions.

In one embodiment, a code image can be downloaded from the host 122, to the processor 120 then to the flash memory 115. Alternately, the flash memory 115 can be loaded before construction of the rotatable media storage device. The executable code can be loaded from the flash 115 to RAM, such as the SRAM 110 or DRAM 118, for execution by the processor 120.

In one embodiment, a search engine is used on a hard disk drive to search both a cache list and a defect list. Entries of cache list point to recently accessed data. Entries of the defect list indicating blocks of the hard disk with a defect. The entries of the defect list can allow a translation between a logical block address and a physical block address. Since data is not stored in the blocks with defects, blocks with defects are not assigned logical block addresses.

The operation of the cache list works as follows. Entries from the cache list can be searched by the search engine to find whether the requested data is in the cache. If the data requested from the hard disk has been recently accessed, it will be stored in the cache. The cache list provides pointers to the stored cache data. If the data is in the cache, the data can be quickly obtained using the entries of the cache list. If the data is not in the cache, the data is then accessed from the hard disk of the hard disk drive a much slower process.

The defect list can be used for translating between a logical block address and a physical block address. Logical block addresses are the addresses used to access data in the hard disk drive. Physical block addresses indicate the actual location of the data within the hard disk drive. Defects complicate the determination of the physical block address from the logical block address. The defect list stores the defect information which can allows the system to determine the correct physical block address from the logical block address. Examples of a logical address to physical address translation is given in the patent application, “Systems and Devices for Bypassing Logical to Physical Address Translation in Rotatable Storage Media”, by Zayas, Attorney Docket No.: PANA-01005US0, Ser. No. 60/533,458 filed Dec. 30, 2003, which is incorporated herein by reference.

Rather than one search engine dedicated to a cache list and one search engine dedicated to a defect list, a single search engine can be used. Arranging the search engine on the hard disk drive so that it can search both the cache list and the defect list provides efficiency for the hard disk drive of the present invention. In one embodiment, the size and format of the entries of the defect list and the cache list can be adjusted to make it easier to use a single search engine. In one embodiment, the entries of the cache list and the defect list are the same size. This makes it easier for the search engine to move through the entries in the search. In one embodiment, the fields of the entries of both the cache list and the defect list match. In one embodiment, the field searched by the search engine is the same size in both the cache list and the defect list.

In one embodiment, each field of the entries of the cache list can have the same size of the corresponding field in the defect list. This further simplifies the operation of the search engine.

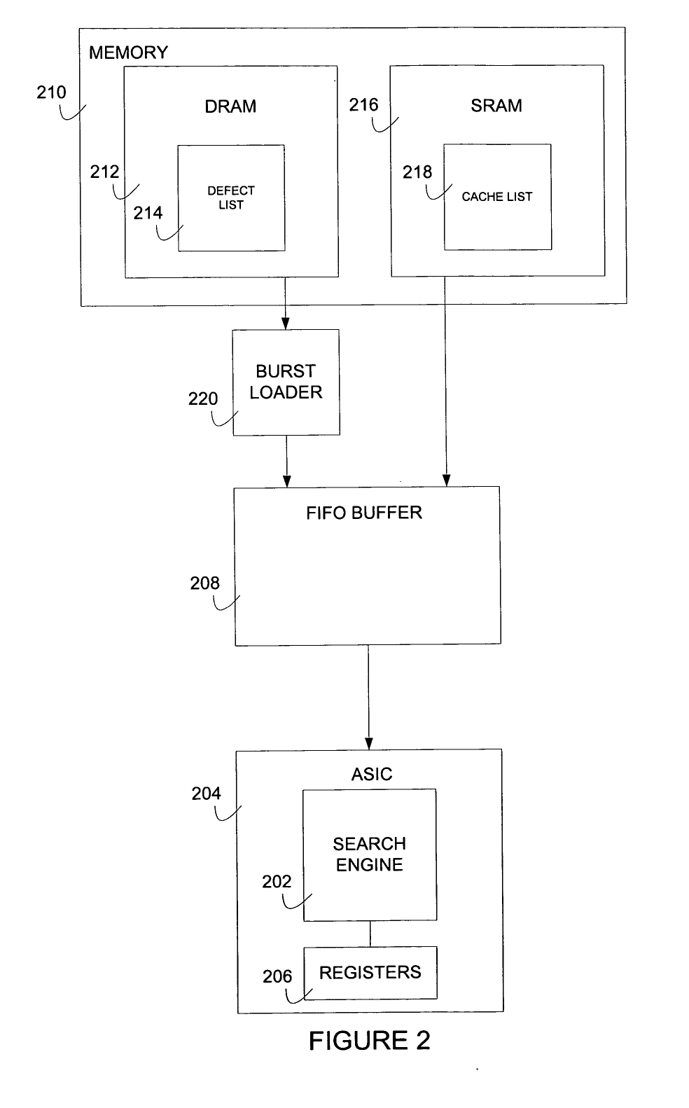

The search engine can be implemented in software. The search engine software can be run by a processor of the hard disk drive. The search engine can also be implemented in hardware. FIG. 2 illustrates a case in which search engine 202 is part of an Application Specific Integrated Circuit (ASIC) 204.

The cache list can be a write cache list and/or read cache list. In one embodiment, the hard disk drive includes both a read cache list and a write cache list. As described below, entries of the cache list can include a logical block address field, a valid count block field, and data pointer field. Entries for the defect list can include a physical block address, a defect length field, and a count of defects to this point.

A parameter can be passed to the search engine to indicate whether the list is a cache list or a defect list. In the example of FIG. 2 the parameter is stored in the register 206 associated with the search engine 202. In another embodiment, the search engine need not know.

In one embodiment, the search engine examines entries loaded into a buffer. FIG. 2 shows an embodiment using a First in First out (FIFO) Buffer 208. In one embodiment, bursts of entries are loaded into the buffer 208 from the memory 210. The memory 210 can include a Dynamic Random Access Memory (DRAM) 212 storing the defect list 214 and a Static Random Access Memory (SRAM) 216 storing the cache list 218. The burst loader 220 can be used for loading bursts of a defect list entries from the DRAM 212. As shown in FIG. 1, the SRAM can be closely associated with the processor and can be made relatively fast where as the DRAM is typically an external chip which is relatively slow but can be much larger than the SRAM.

In one embodiment, the hard disk drive includes multiple search engines. Each search engine can be assigned to search whatever list needs searching.

One example of a search engine design is shown below.

Memory Data Structures:

The search engine can search at least two different lists: a list of segments containing data that is the read or the write cache—or—a list of defects. To accomplish this, the cache list contains double work (64-bit) entries in the following format (shown least significant (LS) word first):

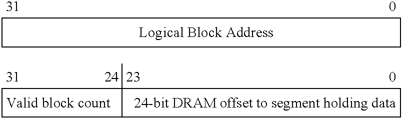

The defect list contain double work (64-bit) entries in the following format:

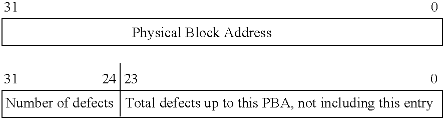

In this case, at most 255 blocks can be represented by a single cache entry and that at most 255 contiguous defects can be presented by a single defect list entry. Further, LBAs or PBAs larger than 32-bits cannot be represented. With 32 bits of PBA, the unformatted capacity is around 2 terabytes. Finally, the segments describing data in the cache can be set to reside in the 16 mega bytes (MB) of the buffer.

While it is required (and the search may be faster) for the defect list to be in ascending PBA order, the cache lists may be in a Most Recently Used (MRU) order. The “valid block count” and “number of defects” field may be zero, and this will cause a match not to occur.

In one embodiment, firmware will “poll” for the outcome and that interrupts are not required. This means that the search must be reasonable fast.

Search Engine Register Interface:

The search engine presents the following registers to a programmer (each presented LS word first and the components may be accessed in byte, word, or longword mode):

The first set of registers defines the span of the list. Only the lower 24-bits are used to set the lower and upper bounds of the list to be searched. The upper byte latches and echoes any value written by firmware. (Firmware will typically write the 32-bit processor address of the start and end of the list).

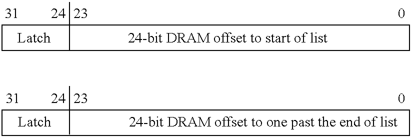

The next set of registers form the search key and the span to search for:

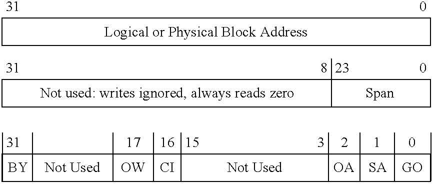

Where the bits mean the following:
BY means busy and remains set in response to the GO or SA push bits being written with a ‘1’. This bit is read-only (part of the status).
OW means “overlaps with”. The search found an entry that overlaps with the entry returned in the next few registers. This bit is read-only (part of the status).
CI means “contained in”. The search found an entry that is held entirely within the entry returned in the next few registers. This bit is read-only (part of status).
OA means “ascending order”. The table is in ascending order by the 32-bit key and may be searched more optimally. This bit is latched and returns the last value written.
SA means “search again”. This continues the search from the settings in the next few registers. If OA is set, the search continues in sequential order. This is a push bit. When written with a ‘1’, it continues the search. It always reads a zero.
GO means “go”. This starts the search anew from the start of the table looking for the first overlap with the table entries in DRAM. This is a push bit. When written with a ‘1’, it starts the search. It always reads a zero.

The next registers return the outcome of the search:

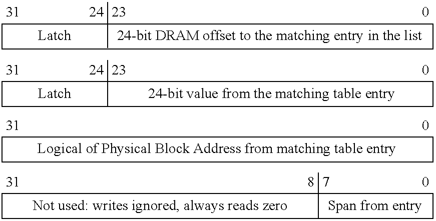

The search engine unpacks the matching entry. The upper byte of the matching entry's segment offset or total defects come from the last value written by firmware. For the defect list, the value is typically written with zero. For the cache list, the value is typically any pointer to the DRAM from the processor's address space.

The speed of the search engine, especially in the sequential mode, is dictated by the burst size of the request it makes from the buffer section. Half of the FIFO buffer can be loaded with data while a search is done to the data in the other half of the FIFO buffer. For example, A 64-byte FIFO buffer can have one half making a burst request for 32 bytes while the other 32 bytes are searched by the search engine.

The priority of the search engine with respect to buffer access should be less than the host and disk transfer machines but higher than the processor's instruction fetches.

Aspects of the Search Engine:

A single search engine can search the read cache, the write cache, the list of factory (splitted) defects, and the list of grown (offline) defects. For parallelism in more performances demanding applications, the search engine can be replicated as many times as required. For performance, the depth of the burst requests can be changed. Requesting data can be done with a burst to improve the utilization of the available bandwidth. The search engine can be built with multiple register sets, allowing one search engine to be switched between multiple searches by control bits. (Similar to a processor that has registers sets dedicated to each execution mode). Firmware can arbitrate for the use of the search engine(s) for many proposes. If there are multiple search engines, they can be treated as resources to be contended for. The search engine strikes a balance between functionality and complexity. The search engine is not coupled to the host interface section or the disk section, reducing risk and complexity. The search engine can search sequentially or do a binary search.

On a failure to find a match, the search engine can leave the registers pointing to the entry that is just higher than the key being searched for, in the case of an ascending order search. This is the insertion point for a new entry and can be used by self-test to insert new defects. Alternately, the “span” field can be the most significant (MS) byte of this word.

Although the above example shows a single table format for the entries, other table formats can be used. For example, a count field can be 16 bits and the pointer can be 16 bit index into a table of pointers or segment number. Alternately, rather than a 1 byte and 3 bytes division, a 2 byte and 2 byte division can be done. The last two bytes of an entry to a defect table can be an index rather than an offset. This allows a larger range of counts and a larger range of defects.

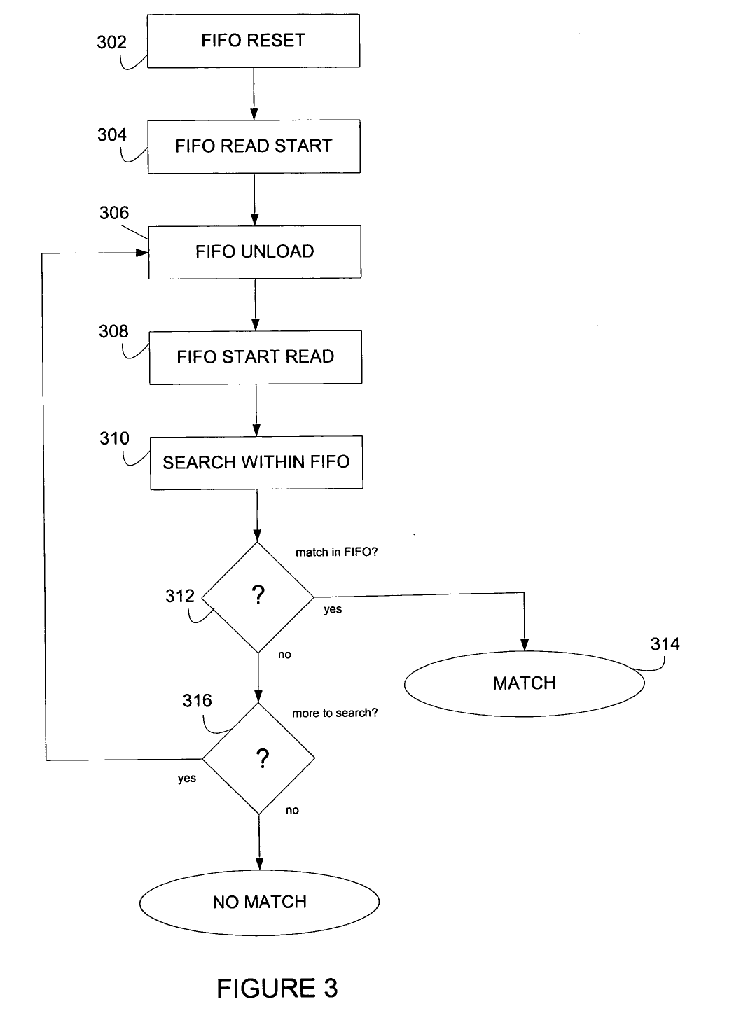

FIG. 3 illustrates the operation of a ping-pong buffer embodiment of the present invention. In step 302 the FIFO buffer is reset, this effectively clears out the FIFO buffer. In step 304, the FIFO buffer read starts; the FIFO buffer read includes a transfer of entries of the cache list or the defect list from the memory into the FIFO buffer buffer. In step 306, once the FIFO buffer is loaded, the FIFO buffer is unloaded to allow for the FIFO buffer to be read again in step 308. Step 310 is a search within the data unloaded earlier from the FIFO buffer is done to determine whether there is a match. If there is a match, the search is finished and the relevant data is provided to the system. Typically, a cache list search is based upon the logical block address and the defect list is searched based upon the physical block address. If there is a match, in step 314, the data in the entry a relative search is provided to the rest of the system. If there is no match, as determined in step 312, in step 316 it is checked to see whether there is more entries to search. If so, once the FIFO finished reading the FIFO buffer is unloaded in step 306.

The operation of the search engine for the cache and defect lists can be synchronous or asynchronous. In a synchronous example, the cache list can be searched first and then upon a cache miss, a logical block address (LBA) to physical block address (PBA) translation is done using the defect list. In an asynchronous example, after a read, the search engine can look for a cache hit, but the search engine could be in use because there is prior write cache data that being written back to the disk and the search engine is in use for the logical to physical address translation.

The write and read cache can be implemented as two separate lists or alternately implemented as a single list. Similarly, the defect list can be broken down into a manufacturing defect list and grown defect list or placed in a single defect list.

In one example, a cache accelerator is implemented as follows:
1. Define in buffer memory a list of “segment entries” composed of 2 32-bit quantities. The and first 32-bits are the LBA. The 2^{nd} 32-bits have a “software defined value” in the lower 24-bit and a sector count in the upper 8-bits (can represent up to 128K-512 bytes). Zero for a sector count means “nothing here”.
2. Define registers that specify the start and length of the table (or start and end of the table if you prefer).
3. Define a state machine that can search this table against an LBA and count loaded into registers. Define a push-bit that requests a “search”. Define a push-bit that requests “search next”. Define a push-bit that requests a “reset to start of table”. The outcome of search could be “overlaps” and further “contained entirely” or “not found” with a pointer to the table entry. Interrupts are optional on search complete.
4. Define the outcome of a search that “overlaps” to be the pointer to the segment entry” and the “software defined value” in two 32-bit registers. The upper bits of the “software defined values” are the upper bits that the processor uses to access the buffer memory.

An example of software implementation in a search engine of one embodiment is shown in appendix I.

The foregoing description of preferred embodiments of the present invention has been provided for the purposes of illustration and description. It is not intended to be exhaustive or to limit the invention to the precise forms disclosed. Many modifications and variations will be apparent to one of the ordinary skill in the relevant arts. The embodiments were chosen and described in order to best explain the principles of the invention and its partial application, thereby enabling others skilled in the art to understand the invention for various embodiments and with various modifications that are suited to the particular use contemplated. It is intended that the scopes of the invention are defined by the claims and their equivalents.

1. A method comprising:
maintaining a defect list on a hard disk drive, entries in the defect list indicating blocks of a hard disk on the hard disk drive with defects;
maintaining a cache list on a hard disk drive, entries in the cache list pointing to recently accessed data; and
using a single search engine to search both the cache list and the defect list.

2. The method of claim 1, wherein the entries of the cache list and the defect list are the same size.

3. The method of claim 1, wherein a field in the entries of both the cache list and the defect list are the same size, the field being examined by the search engine.

4. The method of claim 1, wherein each field of the entries of the cache list has the same size as a corresponding field in the defect list.

5. The method of claim 1, wherein the search engine is implemented in software.

6. The method of claim 5, wherein the search engine is run by a processor of the hard disk drive.

7. The method of claim 1, wherein the search engine is implemented in hardware.

8. The method of claim 1, wherein the search engine is implemented by an ASIC.

9. The method of claim 1, wherein the cache list is a write cache list.

10. The method of claim 1, wherein the cache list is a read cache list.

11. The method of claim 1, including both a read cache list and a write cache list.

12. The method of claim 1, wherein entries for the cache list include a logical block address field.

13. The method of claim 1, wherein entries for the cache list include a valid count block field.

14. The method of claim 1, wherein entries for the cache list include a data pointer field.

15. The method of claim 1, wherein entries for the defect list include a physical block address field.

16. The method of claim 1, wherein entries for the defect list include a defect number field.

17. The method of claim 1, wherein entries for the defect list include a defects to block field.

18. The method of claim 1, wherein a parameter passed to the search engine indicates whether the list is a cache list or defect list.

19. The method of claim 1, wherein the search engine searches entries loaded into a buffer.

20. The method of claim 19, wherein the buffer is a FIFO buffer.

21. The method of claim 19, wherein bursts of the entries are loaded into the buffer from the memory.

22. The method of claim 1, wherein the defect list is maintained in a DRAM and the cache list is maintained in an SRAM.

23. The method of claim 1, whrein the cache list also points to data yet to be written.
